(19) United States
(12) Patent Application Publication
(10) Pub. No.: US 2025/0232148 A1
(43) Pub. Date: Jul. 17, 2025

(54) A SYSTEM AND METHOD FOR SATELLITE IDENTIFICATION

(71) Applicant: Leolabs, Inc., MENLO PARK, CA (US)

(72) Inventors: John Buonocore, Redwood City, CA (US); Matthew Stevenson, San Jose, CA (US); Michael Nicolls, Portola Valley, CA (US)

(21) Appl. No.: 18/881,437

(22) PCT Filed: Jul. 12, 2023
(86) PCT No.: PCT/US2023/027504

§ 371 Date: Jan. 6, 2025

(30) Foreign Application Priority Data
Jul. 13, 2022 (GB) 2210287.5

(51) Int. Cl. G06K 19/07

(52) U.S. Cl. CPC G06K 19/0707; G06K 19/0723

(57) ABSTRACT

A self-contained identification tag arranged to be attachable to a resident space object (RSO) comprising: a processor; an antenna, an energy gatherer arranged to gather energy from the environment; and an energy store arranged to receive and store energy from the energy harvester; wherein the processor is arranged to use energy stored in the energy store to transmit a radio-frequency (RF) identification signal via the antenna. A system for identifying space objects comprising: a radar arranged to determine the orbital path of a resident space object (RSO); and a receiver arranged to receive an identification signal from an identification tag attached to the RSO and to determine a tag identity; wherein the system is arranged to use the determined orbital path and the determined tag identity to determine the identity of the RSO.

The present application relates to a system and method for satellite identification.

### BACKGROUND

When operating an artificial satellite it is important to know the location and orbital parameters of the satellite. However, although space objects can be tracked using radar and other tracking technologies, it may be difficult to identify the tracked space objects. That is, even after the location and orbital parameters of an artificial satellite have been determined it may be difficult or impossible to determine the identity of the satellite.

The current approach for satellite identification generally relies on the spacecraft operator to confirm which satellite is theirs, which poses difficulties if the operator is not cooperative or if the satellite is dead-on-arrival and non-communicative from launch. This also may pose a difficulty for satellite operators, in that if they don't know which satellite is theirs, they must search all satellites to find it. For constellation deployments of large numbers of satellites, discriminating satellites is a significant time sink on initial operations. This may be a particular problem where a number of small satellites, such as cubesats, are deployed together because such satellites may be deployed close together in space, time and trajectory, and in some cases the order of deployment of the different satellites may not be predetermined.

Further, during ongoing tracking of satellites it is desirable to be able to determine the identity of a satellite. For regulatory compliance and liability tracing it is very important to know with certainty the identity of a satellite. However, in practice there are cases when satellites are maneuvering in proximity to one another, or to defunct objects, where it can be difficult to maintain certainty which satellite, or other object, is which, and avoid “cross-tapping” of the different objects.

A number of approaches to satellite identification have been proposed, such as placing radio frequency or optical beacons on a satellite. However, there are problems with this approach, such as size and weight, the need to integrate the beacon power supply with the satellite electronics, and limits on the lifetime of the beacon. Another proposed approach is placing radar or optical reflectors on a satellite. However, a problem with this approach is that it is only possible to provide a very small amount of identifying information using a reflector. Further, all of these approaches have security issues that the satellite identity is made available to any interested party.

Accordingly, it is desirable to provide an improved system and method for satellite identification.

The embodiments described below are not limited to implementations which solve any or all of the disadvantages of the known approach described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the present disclosure provides a self-contained identification tag arranged to be attachable to a resident space object (RSO), the tag comprising: a processor; an antenna, an energy harvester arranged to gather energy from the environment; and an energy store arranged to receive and store energy from the energy harvester; wherein the processor is arranged to use energy stored in the energy store to transmit a radio-frequency (RF) identification signal via the antenna.

In a second aspect, the present disclosure provides a system for identifying space objects, the system comprising: a radar arranged to determine the orbital path of a resident space object (RSO); and a receiver arranged to receive an identification signal from an identification tag attached to the RSO and to determine a tag identity; wherein the system is arranged to use the determined orbital path and the determined tag identity to determine the identity of the RSO.

In a third aspect, the present disclosure provides a method for identifying space objects, the method comprising: attaching a self-contained identification tag to a resident space object (RSO); wherein the tag comprises: a processor; an antenna; an energy gatherer; and an energy store; the method further comprising: gathering energy from the environment using the energy harvester; storing energy from the energy harvester in the energy store; and using the energy stored in the energy store to transmit a radio-frequency (RF) identification signal via the antenna.

In a fourth aspect, the present disclosure provides a method for identifying space objects, the method comprising: determining the orbital path of a resident space object (RSO) using a radar; receiving an identification signal from an identification tag attached to the RSO using a receiver; determining a tag identity; and determining the identity of the RSO from the determined orbital path and the determined tag identity.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is an explanatory diagram of a satellite identification system according to a first embodiment;

FIG. 2 is an explanatory diagram of an identification tag according to the first embodiment;

FIG. 3 is an explanatory diagram of a satellite identification system according to a second embodiment; and

FIG. 4 is an explanatory diagram of an identification tag according to a third embodiment.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

It is generally desirable to be able to positively identify satellites in orbit. The present disclosure provides radio frequency (RF) beacons mounted on the satellites which emit RF signals that can be received by ground stations and used to identify the satellites. Desirable goals for such RF beacons include the following: the beacon should be independent of any satellite power systems; the beacon should not emit any RF signal except when it is over a receiving ground station; the beacon should operate in an open or already licensed frequency band; the beacon should be small in size and light in weight; the beacon should have an operating lifetime of more than 10 years; and the beacon should not use active power sources such as batteries. As will be explained in more detail below, the RF beacons of the present disclosure allow all of these goals to be achieved.

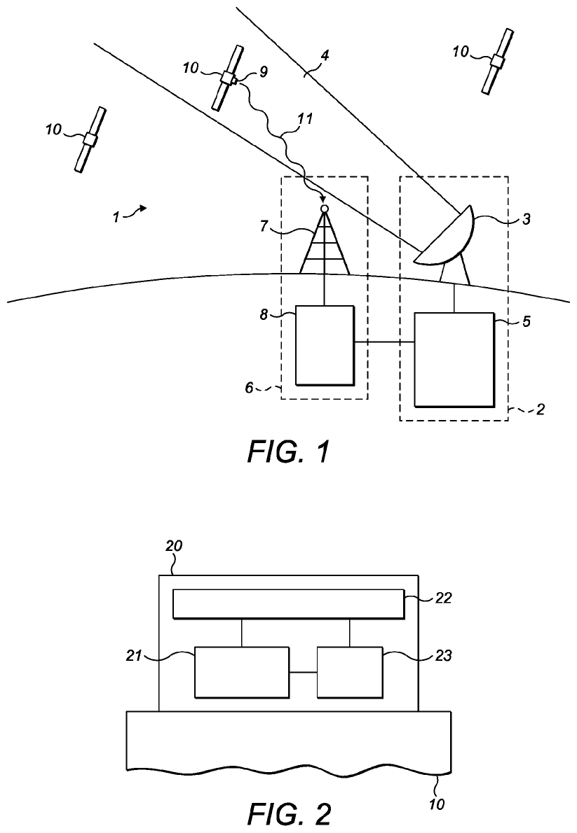

FIG. 1 shows an explanatory diagram of an example of a satellite identification system 1 according to a first embodiment. In the first embodiment of FIG. 1, a ground based radar 2 is used to track satellites 10 and other resident space objects (RSOs) in orbit around the earth. In the illustrated embodiment the radar is a large-aperture S-band pulsed radar used to track satellites and other RSOs in earth orbit. The radar 2 comprises an antenna 3 which emits an RF signal at a predetermined frequency or range of frequencies in a main beam 4 and receives a reflected RF signal reflected back to the antenna 3 by objects within the beam 4. The radar 2 further comprises a tracking system 5 which processes the reflected RF signal received by the antenna 3 to determine the positions over time of the satellites and other RSOs and to determine their orbital tracks, for example by calculating their respective ephemerides.

A tag receiver 6 is co-located with the radar 2. The tag receiver 6 comprises a receiver antenna 7 and a signal processor 8.

An overview of the operation of the satellite identification system 1 is that when a satellite 10, or other RSO, equipped with an identification tag 9 passes through the beam 4 of the radar 2 the identification tag 9 responds to the RF radar signal of the radar 1 by transmitting an RF identification signal 11 comprising an identification code. This RF identification signal is received by the receiver antenna 7 of the tag receiver 6, and the signal processor 8 of the tag receiver 6 analyses the received RF identification signal 11 to determine the identity of the satellite 10. The identity of the satellite 10 may be determined by comparing an identification code derived from the received identification signal 11 to a stored database of identification code of issued identification tags 9 and the respective identities of the satellites 10 the issued identification tags 9 are attached to. The tag receiver 8 then passes the determined identity of the satellite 10 to the tracking system 5 of the radar 2 so that the identity of the satellite 10 can be associated with the determined orbital track or ephemeris. Typically, the RF identification signal 11 is transmitted at a different frequency to the frequency of the radar beam 4, to reduce any possible interference between the radar 2 and the identification signal 11.

The satellite identification system 1 may compile a catalogue of satellites 10 in which the identity of each satellite 10 is stored in association with the identification code of the identification tag 9 on the satellite 10 and the orbital track or ephemeris of the satellite 10. This catalogue may provide a robust means of identifying the satellites 10.

In one example, the radar 2 may provide the determined orbital tracks or ephemerides of the detected satellites and other RSOs, together with any associated satellite identities, to a conjunction warning system. It will be understood that the operation of a conjunction warning system and the taking of appropriate action in response to any identified conjunctions will be more effective and efficient it any satellites 10 involved have been positively identified.

FIG. 2 shows a schematic diagram of an identification tag 20 according to a first embodiment.

The identification tag 20 comprises a processor 21, an antenna 22, and a capacitor 23. The identification tag 20 is attached to a satellite 10.

The processor 21 comprises a stored identification code. When the satellite 10 and the attached identification tag 20 pass through the beam 4 of the radar 2 the antenna 22 gathers or absorbs electrical energy from electromagnetic fields of the received radar signal incident on the antenna 22 and stores this electrical energy in the capacitor 23. The electrical energy stored in the capacitor 23 is used to power the processor 21. The processor 21 measures the amount of electrical energy stored in the capacitor 23, for example, by comparing the voltage difference across the capacitor 23 to a predetermined threshold value. When the processor 21 determines that there is sufficient electrical energy stored in the capacitor 23, for example, when the voltage reaches the threshold value, the processor 21 uses the electrical energy stored in the capacitor 23 to transmit the stored identification code through the antenna 22 as an encoded waveform which forms the RF identification signal 11.

In the first embodiment the identification tag 20 is arranged to transmit the RF identification signal 11 at a transmission frequency which is at a fixed offset from the frequency of the radar 2.

It will be understood from the description above that the identification tag 20 is a passive RFID type tag. Passive RFID tags are generally used at close ranges, typically a few centimeters, to a maximum of about 12 meters. It has never been suggested that passive RFID type tags could be used at kilometer distances, let alone at orbital distances of multiple 100s of kilometers or over 1000 kilometers.

In an example of where the radar 2 is a high-power, large-aperture, S-band pulsed radar having a 50% duty cycle and a transmit pulse length of 12.5 ms, the power incident on the identification tag 20 and the DC energy which the identification tag 20 can harvest from a single incident radar pulse and store in the capacitor 23 at different orbital ranges between the satellite 10 and the antenna 3 of the radar 2 are set out in table 1 below:

TABLE 1

| Range to Satellite | 500 km | 750 km | 1000 km |
|---|---|---|---|
| Power Incident on Tag | −30 dBm | −34 dBm | −36 dBm |
| DC Energy from one Radar | −61 dBm-s | −63 dBm-s | −67 dBm-s |
| Pulse | | | |

The figures in table 1 assume that the identification tag 20 is able to harvest and store 30% of the electromagnetic power incident on the antenna 22 of the identification tag 20.

The required transmit power with which the identification tag 20 transmits the RF identification signal 11 will depend upon the properties of the transmit system of the tag 20 and the receive system of the tag receiver 6, the ambient noise environment, the required signal to noise ratio (SNR) for the RF identification signal 11 to be reliably received, and the distance between the satellite 10 and the receive antenna 7 of the tag receiver 6.

Examples of the required signal strength at the receive antenna 7 (the tag reader) and the corresponding required transmit power for the identification tag at different orbital ranges between the satellite 10 and the receive antenna 7 of the tag receiver 6 are set out in table 2 below:

TABLE 2

| Range to Satellite | 500 km | 750 km | 1000 km |
|---|---|---|---|
| Required Signal Strength at the | −143 dBm | −143 dBm | −143 dBm |
| Reader (assumes 13 dB SNR, 1 kHz | | | |
| bandwidth) | | | |
| Required Transmit Power from Tag | −35 dBm | −31 dBm | −29 dBm |
| (assumes 50% transmit efficiency) | | | |

The examples of table 2 are for an example requiring an SNR of 13 dB, and with typical values for the other parameters identified above.

The energy required in order for the identification tag 20 to transmit the RF identification signal 11 will depend upon the desired number of bits making up the stored identification code, the chip rate (bandwidth) of the identification tag 20, and the required transmit power according to table 2 above. Examples of the number of radar pulses from radar 2 (reader pulses) which are required to be received and harvested for energy by the identification tag 20 in order to provide this required energy for identification codes having different numbers of bits and different ranges between the satellite 10 and the antenna 3 of the radar 2 are set out in table 3 below:

TABLE 3

| Range to Satellite | 500 km | 750 km | 1000 km |
|---|---|---|---|
| Number of Reader Pulses (16 ms tag | 15 | 75 | 237 |
| pulse, 48 bits, 1 kHz bandwidth) | | | |
| Number of Reader Pulses (8 ms tag | 8 | 38 | 119 |
| pulse, 24 bits, 1 kHz bandwidth) | | | |
| Number of Reader Pulses (4 ms tag | 4 | 19 | 60 |
| pulse, 12 bits, 1 kHz bandwidth) | | | |

As discussed above, the duty cycle of the radar 2 in this example is 50% with a 12.5 ms transmit pulse. Thus, the time required for the identification tag 20 to harvest sufficient energy from the radar signal to transmit the identification signal 11 will be the number of reader pulses indicated by table 3 multiplied by 5 ms. It will be understood that the power required for operating the identification tag 20 functions other than transmitting the identification signal are trivial by comparison, and do not need to be considered here.

In one example shown in table 3 for a system using a 12-bit code with a satellite at 500 km range, four 1 ms radar pulses will be required to charge the identification tag 20 with sufficient energy to transmit the identification signal 11, which will take 20 ms. Once the identification tag 20 is charged, the identification tag 20 will transmit the identification signal 11 comprising a 12 bit code over a 4 ms period. In another example shown in table 3 of a system using a 48 bit code at a range of 750 km, seventy five 1 ms radar pulses are required, which would take 375 ms. The identification signal will then transmit the identification signal 11 comprising a 48 bit codes over a 16 ms period.

In this example a satellite 10 is typically within the beam 4 of the radar 2 for greater than 1.0 seconds, and it can be seen from the worked examples above and the figures in table 3 that this will be generally be sufficient for the identification tag 20 to harvest sufficient energy to transmit the identification signal 11. Only in the most demanding use case shown in table 3, where a 48 bit code is used on a satellite at a range of 1000 km, will the time required to charge the identification tag 20 be so high, about 1.185 seconds, to possibly be a problem.

Accordingly, it can be seen that the identification tag 20 will be able to harvest sufficient energy to be able to transmit the identification signal in most situations. However, it may be necessary to limit the length of the identification code used for identification tags 20 located on satellites 10 which are to be sent into high orbits.

It will be understood that because the identification tag 20 of the first embodiment uses power harvested from the radar 2 signal to transmit the identification signal 11, the identification tag 20 will not only emit the RF identification signal 11 when it is above, or in other words, within the beam of, the radar 2. Accordingly, the identification tag 20 achieves the objective of not emitting any RF signal except when it is over the tag receiver 8, which may be desirable to minimize the risk of interference with the operation of the satellite 10, and to reduce RF clutter and noise which could impact the operation of other satellites. Further, the identification tag 20 is self-contained, and is independent of any satellite power systems, which may be desirable to ensure that the identification tag 20 does not interfere with operation of the satellite 10, and to allow the identification tag 20 to continue operating even if the satellite 10 itself stops functioning, such as suffering a power supply failure. Further, it is not necessary to test and certify the identification tag 20 as compatible with the systems of the satellite 10. Further, the identification tag 20 can operate in the same open or licensed frequency band as the radar 2, but at an offset frequency. This may avoid problems of the identification signal interfering with other users of the electromagnetic spectrum. Further, the identification tag 20 does not comprise any active power source, such as a battery. Accordingly, the risk of a malfunction of an active power source harming the satellite 10 is avoided. The identification tag 20 uses power harvested from the radar 2, and accordingly the operating lifetime of the identification tag 20 is limited only by the lifetime of its electronic components, which may readily be arranged to be greater than 10 years even in a space environment by selection of suitable components. This may provide the advantage that the identification can continue operating for the entire period that the satellite 10 is in orbit, which may extend long after the satellite 10 systems have stopped functioning. The identification tag 20 may be small in size, typically a few centimeters, and may have a weight of less than 100 grams, allowing one or more identification tags to be placed on a satellite 10 without significant effect on the operation of the satellite or the launch weight of the satellite 10.

The Identification tag 20 of the first embodiment may provide advantages over passive reflectors, for example a Van Atta array, that the form of the identification signal 11, such as the identification code can be selected freely. Passive reflectors are generally limited to producing a return signal having a form which is dependent on, and generally closely related to, the form of the illuminating radar signal. In particular, a passive reflector cannot transmit freely selectable code when illuminated by a radar signal. The identification tag 20 of the first embodiment may provide the advantage of being smaller that a passive reflector, for example a Van Atta array.

In some examples, it may be desired for the identification signal 11 to comprise an encrypted identification code so that only an authorized user of the system 1 can use the identification signal 11 to identify the satellite 10. Accordingly, the identification signal 11 may comprise an encrypted identification code. However, if the encrypted identification code is unchanging, anyone receiving the identification signal 11 can readily use it to identify the satellite 10 on which identification tag 20 is located as being the same satellite 10. This is particularly the case because the identification tag 20 will transmit the identification signal 11 is response to being illuminated by any radar signal having sufficient incident power and approximately the same frequency as the radar 2.

Accordingly, the identification tag 20 may be arranged to transmit an identification signal 11 comprising a different encrypted identification code on each occasion it is transmitted. In one example a predetermined pseudo-random series of identification codes may be used, and the tracking system 5 can compare the received codes to lists of which codes are assigned to which satellite 10. In another example, the identification tag 20 may be arranged to combine the identification code of the satellite 10 with the time in a predetermined manner and to encrypt the result before transmission, and the tracking system 5 can be arranged to decrypt the received identification signal 11 and recover the identification code of the satellite 10. In another example, the identification tag 20 may be arranged to combine the identification code of the satellite 10 with the counter or a random value in a predetermined manner and to encrypt the result before transmission, and the tracking system 5 can be arranged to decrypt the received identification signal 11 and recover the identification code of the satellite 10.

All of the above examples may be used to ensure that only the authorized user of the system 1 can use the received identification signal 11 to identify the satellite 10.

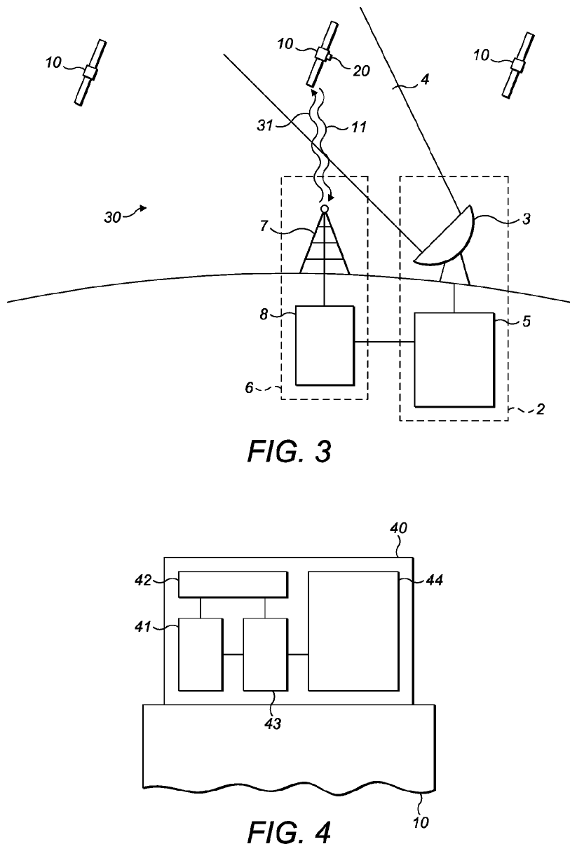

FIG. 3 shows a satellite identification system 30 according to a second embodiment.

As is explained above, in the satellite identification system 1 according to the first embodiment the identification tag 20 will transmit an identification signal 11 comprising an identification code in response to illumination of the identification tag 20 by the radar 2. The satellite identification system 30 is similar to the satellite identification system 1 of the first embodiment, but is modified to transmit the satellite identification system 30 of an identity request signal.

As is shown in FIG. 3, the satellite identification system 30 according to the second embodiment comprises a radar 2 and a tag receiver 6 co-located with the radar 2, similarly to the first embodiment. The tag receiver 6 comprises a receiver antenna 7 and a signal processor 8, and further comprises an interrogation signal transmitter 31.

In operation of the satellite identification system 30 the tag receiver 6 is arranged to transmit an interrogation signal 32 from the interrogation signal transmitter 31 through the antenna 7 when it is desired to identify a satellite 10. In the satellite identification system 30 the identification tag 20 is arranged to transmit the identification signal 11 only in response to receiving the interrogation signal 32. It will be understood that the identification tag 20 must still pass through the beam 4 of the radar 2 in order to harvest the power required to transmit the identification signal 11, but in the satellite identification system 30 according to the second embodiment the identification tag 20 does not automatically transmit the identification signal 11 when it has sufficient energy to do so.

The satellite identification system 30 according to the second embodiment may avoid unintended transmission of the identification signal 11 in response to incident radar signals, and so may more effectively avoid emitting any RF signal except when it is over the tag receiver 6.

In some examples, the satellite identification system 30 according to the second embodiment may employ encryption so that only an authorized user of the system 1 can use the identification signal 11 to identify the satellite 10.

In one example of an encryption arrangement, the identification tag 20 may contain a tag-specific private key and a tag receiver public key, and the tag receiver 6 may a tag receiver private key and a list of tag-specific public keys for different identification tags 20. In operation, the tag receiver 6 may transmit an interrogation signal 32 which is encrypted, for example the interrogation signal 32 may comprise an encrypted combination of the time and a random challenge. The identification tag 20 decrypts the interrogation signal 32, and if it identifies the interrogation signal as genuine, responds by transmitting the identification signal 11 comprising an encrypted combination of the identification code, time and a random challenge. The tag receiver 6 decrypts the received identification signal 11 to obtain the identification code of the identification tag 20.

In other examples, different encryption arrangements may be used. In some examples, the interrogation signal 32 may comprise an encrypted combination of the time, a random challenge, and the identification code of the identification tag 20 to which the interrogation signal 32 is directed. In such examples the identification tag 20 may be arranged to respond only to an interrogation signal 32 including its identification code. In some examples, the identification tag 20 may be arranged to rate limit responses. In some examples, the identification tag 20 may further comprise a clock, and may be arranged to ignore old interrogation signals 32, to prevent “replay” type attacks using a recorded interrogation signal 32. In some examples, the interrogation signal 32 may comprise a counter, random value, or pseudo-random value instead of a time value, to prevent “replay” type attacks.

In general, it is desirable that each identification tag 20 has a unique identification code so that the identification tags 20, and thus the satellites 10 they are attached to, can be unambiguously identified. This may be absolute uniqueness, where each identification code is used by only one identification tag 20, or an identification code is re-used only when an identification tag 20 using the code is confirmed to be out of service, for example when the satellite 10 to which the identification tag 20 is attached has been de-orbited. In other examples the identification codes may be effectively unique, where the same identification code may be used for identification tags 20 to be attached to satellites 10 in situations where there is no likelihood of contusion, For example, the same identification codes may be used by identification tags 20 to be attached to satellites 10 in such different orbits that they can be readily distinguished by the combination of information from the radar 2 and the tracking system 5.

In some use cases of the satellite identification systems according to the first and second embodiments, identification tags 20 or 30 may be placed on a large number of different satellites 10 which are all to be part of a single launch or constellation, or multiple identification tags 20 or 30 may be placed on multiple parts of a single satellite 10. In such use cases it may occur that multiple different identification tags 20 or 30 are powered up simultaneously by the radar beam 4, or interrogated simultaneously by the interrogation signal 32. In such examples, it may be desirable for the identification tags 20 or 30 to use orthogonal communication codes, so that the identification signals 11 from the multiple identification tags 20 or 30 can be received and correctly decoded even when the multiple identification tags 20 or 30 transmit at the same tune. The orthogonal communication codes may be achieved using something similar to CDMA or OFDM, where each identification tag 20 or 30 is assigned a particular chip sequence or multiplexed transmission frequency.

In some examples, it may be arranged for all identification tags associated with a single satellite, single launch, or single constellation to use orthogonal communication codes, without arranging for the communication codes used by all identification tags to be orthogonal.

In the first and second embodiments described above a separate radar antenna 3 and receiver antenna 7 are used. In other examples, these antennas may be combined, and the radar antenna 3 may be used both to transmit and receive the radar signal, and to receive the identification signal.

FIG. 4 shows a schematic diagram of an identification tag 40 according to a third embodiment. The identification tag 40 may be used instead of the identification tag 20 described above according to the first and second embodiments.

The identification tag 40 comprises a processor 41, an antenna 42, a capacitor 43, and a solar cell 44. The identification tag 40 is attached to a satellite 10. The identification tag 40 of the third embodiment is similar to the identification tag 20 of the first and second embodiments, with the difference that the identification tag 40 is an active tag having a power source other titian the radar.

In operation of the identification tag 40, when the satellite 10 and the attached identification tag 40 are exposed to sunlight, or other sufficiently intense light, the solar cell 44 generates electrical energy from light incident on the solar cell 44 and stores this electrical energy in the capacitor 43. The electrical energy stored in the capacitor 43 is used to power the processor 41. The processor 41 comprises a stored identification code. When the satellite 10 passes through the beam 4 of the radar 2, the radar signal is received through the antenna 42. When the processor 41 determines that the received radar signal has reached a predetermined signal strength, the processor 41 uses the electrical energy stored in the capacitor 43 to transmit the stored identification code through the antenna 42 as an encoded waveform which forms the identification signal 11. The solar cell 44 may comprise an area of photo-voltaic (PV) material.

The required transmit power for the identification tag 40 is a function of the properties of the transmit and receive systems, the noise environment, the required SNR, and the distance between the satellite 10 and the receiver antenna 7. In an example where the identification tag 40 comprises a solar cell of 4 mm² collecting area at an efficiency of 20%, generating approximately 1 dBm of power in direct sunlight, where direct sunlight is assumed to have a power of 1000 W/m2, and arranged to transmit the identification signal 11 using the C-band ISM allocation at 5.8 GHz, with a 16 ms transmission time of the identification signal 11 comprising a 48 bit identification code, and the receiver antenna 7 of the tag receiver 6 comprises a 0.5 meter dish, with 27 dBi of gain, the required signal transmission strength at the identification tag 40 and the corresponding required transmission power at different orbital ranges between the satellite 10 and the receiver antenna 7 of the tag receiver 6 are set out in table 4 below:

TABLE 4

| Range to Satellite | 500 km | 750 km | 1000 km |
|---|---|---|---|
| Required Signal Strength at the | −143 dBm | −143 dBm | −143 dBm |
| Reader (assumes 13 dB SNR, 1 kHz | | | |
| bandwidth) | | | |
| Required Transmit Power from Tag | −8 dBm | −4 dBm | −2 dBm |
| (assumes 50% antenna efficiency) | | | |

The corresponding powers required for transmission of a single full length sequence, and the resulting duty cycle given the power available from the solar cell, are set out in table 5 below:

TABLE 5

| Range to Satellite | 500 km | 750 km | 1000 km |
|---|---|---|---|
| Energy Required for One | −23 dBm-s | −19 dBm-s | −17 dBm-s |
| Transmission | | | |
| Tag Duty Cycle | 100% | 100% | 58% |

It can be seen from table 5 that a small solar cell of 4 mm² can provide sufficient energy to power transmission from the identification tag 40 at up to 1000 km range, with a 58% duty cycle.

The identification tag 40 provides similar advantages to the identification tag 20 of the first and second embodiments. Further, it may be possible to make the identification tag 40 smaller than the identification tag 20 because the use of the higher-frequency C-band may allow the antenna to be smaller than the lower-frequency S-band antenna of the identification tag 20. In some use cases it may be preferred to use the C-band in an ISM allocation for the identification signal 11.

The identification tag 40 uses the receiver antenna 7 to receive the identification signal 11, and in some examples may also use the receiver antenna 7 to transmit the interrogation signal 32 to trigger the transmission of the identification signal 11. The receiver antenna 7 may be smaller than the radar antenna 3, and in some examples the receiver antenna may be arranged to be steerable to allow the receiver antenna 7 to track satellites of interest. This may enable a longer duration view of a satellite 10 of interest than in systems according to the first and second embodiments, where the satellite 10 must be within the beam 4 of the radar 2 in order to be powered, which may assist in successfully receiving the identification signal from an identification tag 40 on the satellite 10.

In some examples the encryption tag 40 may comprise a battery for energy storage instead of, or in addition to, the capacitor.

For the avoidance of doubt, the various encryption and signal orthogonality options discussed above can also be used with the encryption tag 40 of the third embodiment.

In the third embodiment described above the encryption tag 40 may be arranged to transmit the identification signal 11 at predetermined times, instead of in response to an interrogation signal 32.

In the second and third embodiments described above the tag receiver 8 uses a single antenna 7 to transmit the interrogation signal 32 and receive the identification signal 11. In other examples separate transmit and receive, antennas may be used for these different functions.

In the third embodiment described above the encryption tag 40 comprises a solar cell to generate power to operate the encryption tag 40. In other examples, the encryption tag 40 may comprise additional or alternative arrangements to harvest power from the environment, such as generating power from vibration of the satellite.

In the embodiments described above an antenna 7 is used to receive the identification signal 11, and in some examples to also transmit an interrogation signal 32. In some examples the antenna 7 may be omitted and the antenna 3 of the radar 2 may be used as a common antenna to perform these reception and transmission tasks in addition to radar signal transmission and reception.

The above embodiments use a high-power, large-aperture, S-band pulsed radar. In other examples alternative types of radar may be used.

The above embodiments comprise a ground based radar. In other examples a differently located radar may be used. In some examples the radar may be located on a space vehicle or satellite.

In the illustrated embodiments the radar 2 and the receiver 6 are shown located together at a single location. In other examples the radar 2 and the receiver 6 may be located at spaced apart locations. Further, in some examples the antennas of the radar 2 and/or the receiver 6 may be located remotely from the other parts of the radar 2 and/or the receiver 6 and connected by suitable communication means.

The above embodiments employ an identification signal comprising an identification code. In other examples the identification signal may not comprise a code, but may allow identification based upon other characteristics of the identification signal.

The above embodiments describe identification tags located on satellites. Typically the identification tags are attached to the satellites before launch. However, in some examples identification tags may be placed on satellites, or on other orbital objects, in space. This may, for example, be carried out by a dedicated satellite in order to improve identification and tracking of satellites and other orbital objects which are already in orbit.

In the above embodiments some functionality may be provided by software. In other examples this functionality may be provided wholly or in part in hardware, for example by dedicated electronic circuits.

In the above embodiments parts of the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Computer programs and computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

The terms ‘processor’ and ‘computer’ are used herein to refer to any device with processing capability such that it can execute instructions.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

It will be understood that the above description of a preferred embodiments is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A self-contained identification tag arranged to be attachable to a resident space object (RSO), the tag comprising:
a processor;
an antenna,
an energy harvester arranged to gather energy from the environment; and
an energy store arranged to receive and store energy from the energy harvester;
wherein the processor is arranged to use energy stored in the energy store to transmit a radio-frequency (RF) identification signal via the antenna.

2-38. (canceled)
